(19) United States
(12) Patent Application Publication
(10) Pub. No.: US 2019/0230878 A1
(43) Pub. Date: Aug. 1, 2019

(54) Tray System for Use in Hydroponic Growing

(71) Applicant: Triple B Corporation, Seattle, WA (US)

(72) Inventor: Dan Albert, Seattle, WA (US)

(73) Assignee: Triple B Corporation, Seattle, WA (US)

(21) Appl. No.: 15/882,699

(22) Filed: Jan. 29, 2018

(51) Int. Cl. A01G 31/06

(52) U.S. Cl. CPC A01G 31/06; A01G 2031/006

(57) ABSTRACT

Disclosed is a tray system for use in hydroponic growing, the system including a framework with at least one shelf, a shelf liner sized and configured for placement on the at least one shelf of the framework, a hydroponic grow tray sized and configured for placement on the shelf liner, the grow tray including a first side, a second side and a grow medium portion between the first side and second side, the tray configured in place such that there is a downward slope from the first side to the second side, the tray further comprising: a water receiving surface at the first side of the tray, the water receiving surface positioned to receive water from a source of water mounted to the framework, and sloped such that water received is directed to the grow medium portion of the tray, and a tray drain at the second side of the tray configured to receive water from the grow portion.

### CROSS REFERENCE TO RELATED APPLICATION

This application does not claim the benefit of any other patent application.

### TECHNICAL FIELD

This invention pertains to a tray system for use in hydroponic growing.

### BACKGROUND OF THE INVENTION

Hydroponic growing systems have been known for many years and as the industry has progressed and more commercial production is accomplished through hydroponic grow systems, there is a need to reduce the labor-intensive nature of the growing and to streamline the growing process. The types of crops that may be grown in this way is near unlimited, but may include, without limitation, fruit, vegetables, micro greens, plants and many others.

In many instances the growing process occurs on many vertical levels to save square footage in the facility and this further increases the labor and equipment needed for efficient operations.

It is also desirable in some embodiments of the invention to minimize the number and type of structural components that must be custom manufactured or custom sized so that as operations are scaled, costs are contained.

In a typical hydroponic environment there are containment vessels, which are typically trays, troughs or other components that contain or house the crop. Typically a growing medium (or media) is used to develop the seeds and then as a structure or media to grow the plants or crop. The grow mediums are configured to allow some plant/seed growth and also to facilitate the flow of water, nutrients and other substances through the grow area. Typically, the fluid is water or water based, and within the water various additives may be included (such as new nutrients, fertilizer, and other substances beneficial to the growth process of the particular crop being grown). Generally, the containment vessels are configured to receive the water at an inlet side and allow it to flow through the growth medium, such that the water would then exit at an outlet side at an opposing end of the containment vessel or tray from the inlet side.

In a typical tray-based system, one or more water inlet pipes are used to deliver water to a first end of the tray (as can be seen for example in FIGS. 1 & 9). Typical current tray systems require manually moving or repositioning the water inlet pipes when a tray is to be removed from the framework, and then again when a tray is inserted within the framework. This can be difficult and time consuming especially in vertical systems wherein the water supply is difficult to reach.

It is therefore one object of some embodiments of this invention to provide a hydroponic grow tray system which eliminates the need to move or alter the water inlet pipes when removing and reinstalling trays.

The water moving through the grow medium and organics on the trays can pick up various debris, some of which will flow with the water towards the second end of the tray and can cause clogging or blockage of the drain aperture(s) or tray drain. This type of clogging requires additional manual labor to unclog the tray drains and can lead to an undesirable accumulation of water and debris in part or all of the tray.

It is an object of embodiments of this invention to provide a hydroponic grow system which inherently through its configuration reduces or impedes the debris from flowing through the tray drain aperture. Embodiments of this invention have the advantage of providing a raised perimeter or lip which reduces the flow of debris through the drain aperture and reduces or eliminates clogging of the tray drain aperture.

It is also desirable and an object of some embodiments of this invention, to utilize frameworks and standard components that can be purchased off the shelf and do not need to be custom manufactured, such as pallet rack systems, which are commonly available. Embodiments of this invention have the advantage that the trays are particularly configured for standard or commonly sized palette racks (such as those which may have an approximate four foot by eight foot footprint in each section or between vertical support).

Embodiments of this invention configure and size the trays to fit side-by-side within the particular framework such that they can be easily removed without altering the water piping or other components. Some embodiments include trays that can slide into place under a water pipe inlet and then be slid out without requiring any additional labor to reconfigure any other components. Trays used in this embodiment have a water receiving surface area which is preferably sloped to receive the water at a first side in the tray. The configuration and slope of these trays then direct the water through the grow medium and to the second end of the tray where the water outlet aperture or drain is located.

Other objects, features, and advantages of this invention will appear from the specification, claims, and accompanying drawings which form a part hereof. In carrying out the objects of this invention, it is to be understood that its essential features are susceptible to change in design and structural arrangement, with only one practical and preferred embodiment being illustrated in the accompanying drawings, as required.

### BRIEF DESCRIPTION OF THE DRAWINGS

Preferred embodiments of the invention are described below with reference to the following accompanying drawings.

FIG. 1 is an elevation perspective view of one example embodiment of a hydroponic tray grow system utilizing a standard pallet rack as its framework;

FIG. 2 is a top view of an example of a shelf liner with an integral drain which may be utilized in some embodiments of the invention;

FIG. 2A is an elevation view of the shelf liner illustrated in FIG. 2 showing the sloped nature of the liner and it's drain;

FIG. 3 is an elevation view of a shelf liner with a drain which may be utilized in embodiments of the invention;

FIG. 4 is an elevation view of the example of the shelf liner illustrated in FIG. 3;

FIG. 5 is a top view of a tray which may be utilized in embodiments of this invention;

FIG. 6 is an elevation view of the tray illustrated in FIG. 5;

FIG. 7 is a cross-sectional elevation view of the example of the tray shown in FIG. 6;

FIG. 8 is an elevation view of a tray configuration which may be utilized in some embodiments of this invention; and

FIG. 9 is a side perspective view of trays in place on the framework and which may be utilized in some embodiments of this invention, showing the water input pipes, grow lights and a pallet rack framework.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

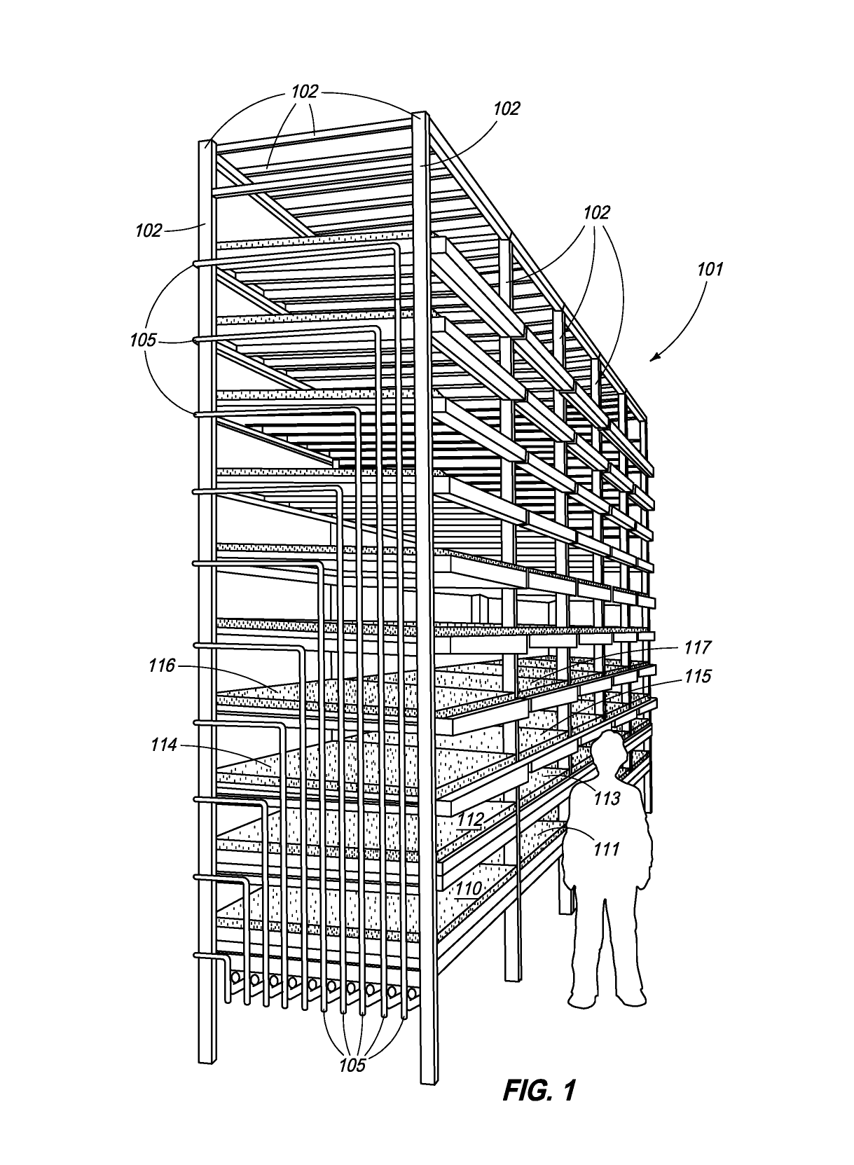

FIG. 1 is an elevation perspective view of one example of an embodiment of a hydroponic tray grow system 101 contemplated by this invention, one which preferably utilizes a standard or commonly sized pallet rack 102 as the framework 102.

It will be appreciated by those of ordinary skill in the art that there are various standard and optional components known and used in most hydroponic systems. The pallet rack framework is shown with five bays, which may be four (4) feet by eight (8) feet in dimension, or any other dimensions for that matter. Standard conduit or piping 105 may be utilized to route and deliver water and other fluid-based products to the trays on the framework.

FIG. 1 also shows tray configurations with grow media 110, 112 and 113 and/or seeds/crops therein, such as trays 111, 114, 115, 116 and 117. While FIG. 1 shows one continuous tray within each section of the framework 102, there would more commonly be two to six individual trays within each section of the framework, with no particular number of trays being required to practice this invention.

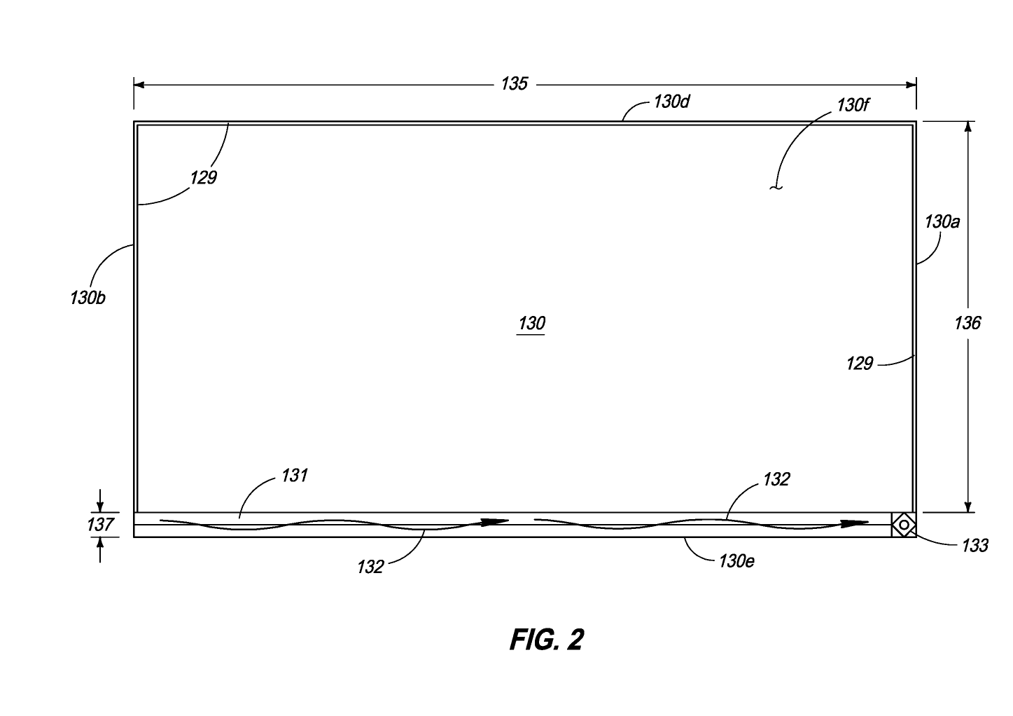

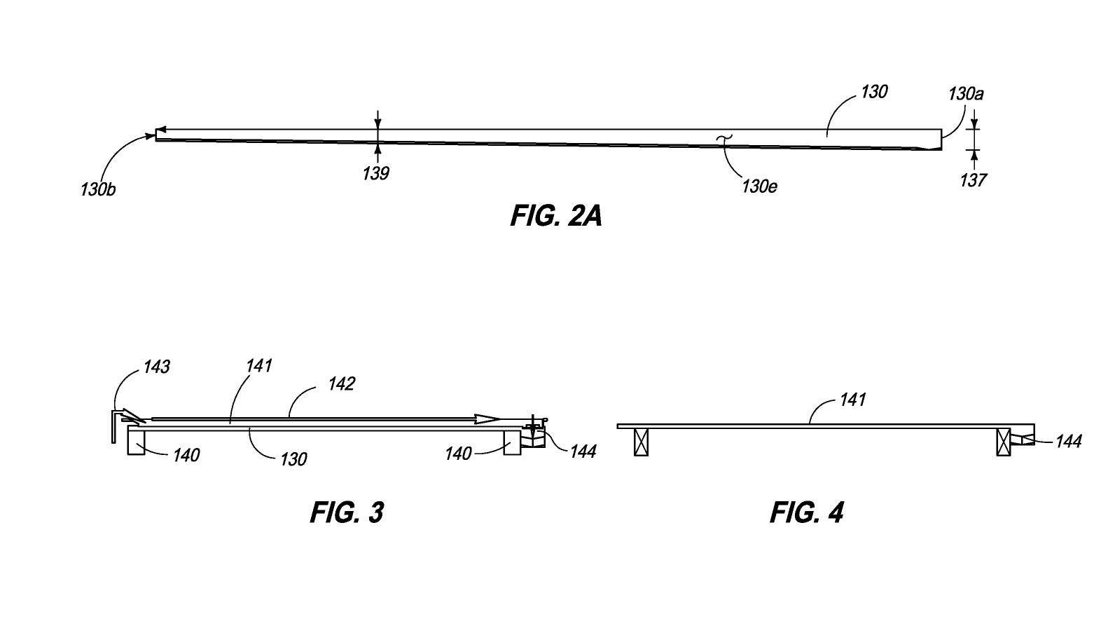

FIG. 2 is a top view of an example of a shelf liner 130 with an integral drain 133 which may be utilized in some embodiments of the invention. The shelf liner 130 includes first side 130a, second side 130b, third side 130d, fourth side 130e, and top surface 130f. The shelf liner 130 in FIG. 2 has length 135, width 136, drain 133 with drain channel 131 having a width 137. The drain channel 131 is sloped downwardly toward drain 133, with the arrows 132 representing the flow of water or fluid from the second side 130b of the shelf liner 130 through the drain channel 131 and to the drain 133.

Utilizing the shelf liner 130 in embodiments of this invention provide a redundant catchment system which enable the trays to be placed on the shelf liner and removed from the shelf liner without having to turn the water supply on and/or off. In FIG. 2 a water control channel 129 is shown which merely provides a catch channel for catching water from the source of water even when a tray is not on the shelf liner 130. The use of a shelf liner 130 in such a way facilitates the operational characteristics and time saving in moving trays on and off the shelf liner in a more efficient and effective way.

FIG. 2A is an elevation view of the shelf liner 130 illustrated in FIG. 2, showing the first side 130a of the tray, the second side 130b of the tray, with a tray sidewall height 139 in a middle portion of the shelf liner 130, with a tray sidewall height 137 at the first side 130a of the shelf liner 130.

FIG. 3 is an elevation view of an exemplary shelf liner 141 setting on pallet rack framework 140. Arrow 142 represents the direction of flow of water within the shelf liner 141 and arrow 143 represents introduction of water into shelf liner tray 141. FIG. 3 also shows shelf liner drain 144 which receives water from the drain 133 in the shelf liner 141 (which will be shown and described more fully in later figures).

FIG. 4 is an elevation view of the example of a shelf liner 141 with shelf liner drain 144. It will be appreciated by those of ordinary skill in the art that the shelf liner 141 is preferably sized and shaped to accommodate one or more trays 130.

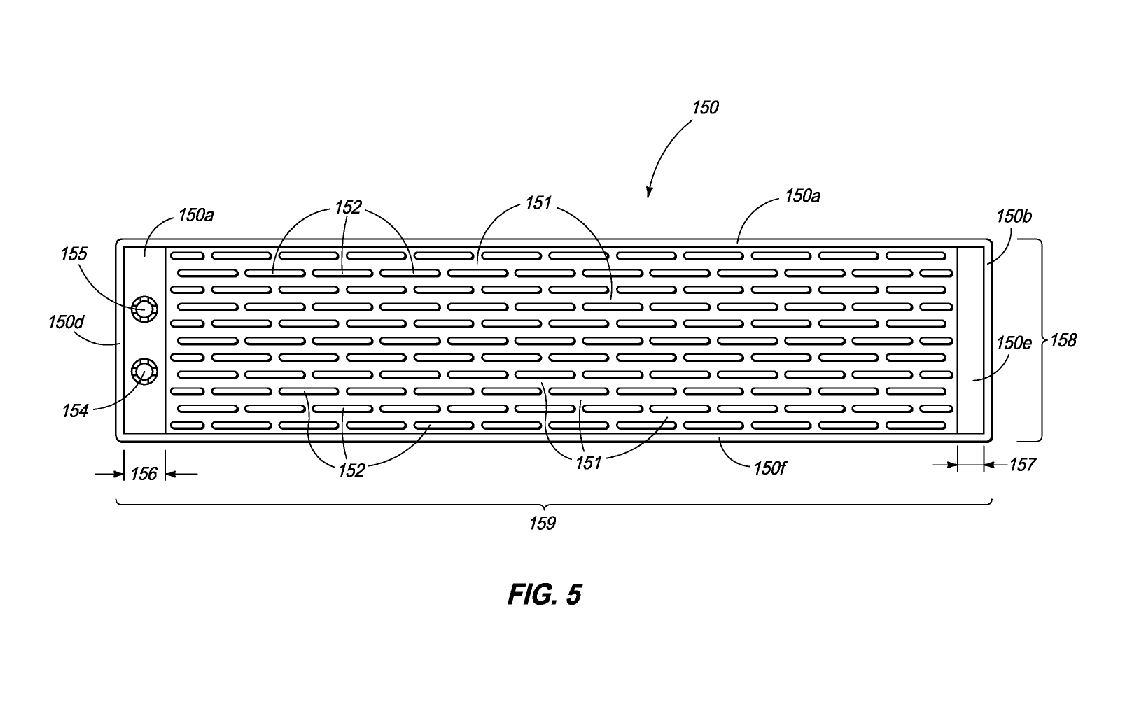

FIG. 5 is a top view of an example of a tray 150 which may be utilized in embodiments of this invention, showing first side 150b, second side 150d, third side 150a and fourth side 150f. The bottom surface 151 of tray 150 includes several elongated raised sections 152, which assist in the directing of water flowing from the first side 150b of tray 150 to the second side 150d of the tray 150. It should be noted that the raised sections or ridges 152 may be elevated any one of a number of different heights and configured or aligned in any one of a number of different patterns, with no one in particular being required to practice this invention.

In determining the desired height of a ridge 152, consideration must be given to the growing medium used and whether the growing medium gets enough water contact or whether an undesirable amount of water runs beneath it. If on the other hand the ridges are not tall enough, in some embodiments this may reduce or impede the oxygenation, and so those of ordinary skill in the art should note that these dimensions are preferably balanced to the application. In some cases, a ridge height of approximately one-quarter inch (0.25″) and the spacing between ridges may be approximately one and one-eight inches (1.128″) in some embodiments of the invention (though no specific dimension is required to practice the invention). The elevated ridges or raised sections 152 are also generally configured to help direct the flow of the fluid or water from the inlet side (the first side 150b) to the drains 154 and 155 at the exit or discharge side (the second side 150d of the tray 150).

Water receiving surface 150e of tray 150 is a sloped surface upon which water from the water piping can be delivered or deposited and said surface would preferably be sloped downwardly to cause the water to flow into the main portion or grow media portion of the tray 150, and then toward the first side 150d (the drain side). The water receiving surface 150e can be any one of a number of different configurations, slopes and sizes, but is intended to be desirably configured to receive water from the source of water (which is typically water piping or conduit), and then directed into the tray. At the first side 150d is the drain surface 150a with preferably (but not required) raised peripheral areas around the drains 154 and 155, as is shown and described in later figures.

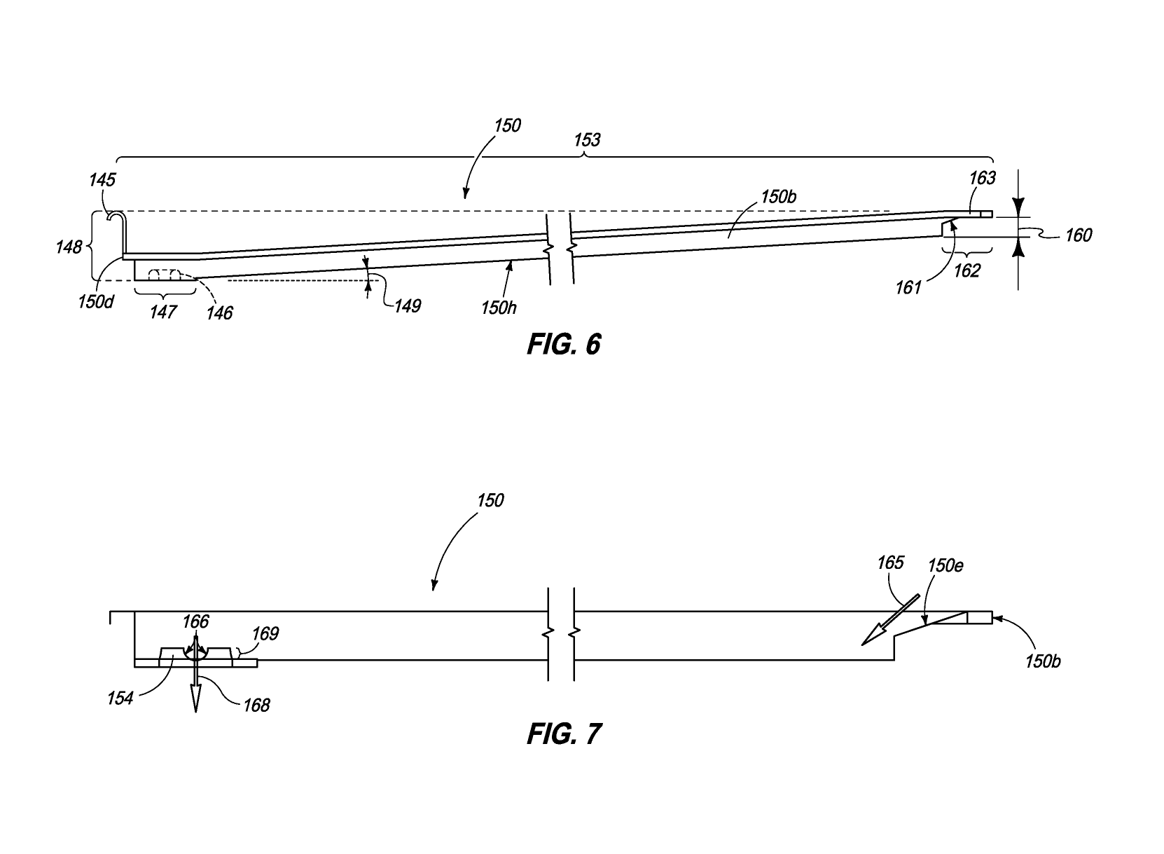

FIG. 6 is an elevation view of the tray 150 shown in FIG. 5, illustrating first side 150d, fourth side 150b, tray undersurface 150h with a tray wall height 160. The undersurface 161 of the water receiving surface 150e shown in FIG. 5, and shows a slope which on the upper side, namely the water receiving surface 150e, to move water received into the tray 150. The lip portion 163 can be sized as desired for the water receiving surface and is shown with a length 162. It will be appreciated by those of ordinary skill in the art that the relative sizes and configuration of the lip portion 163 and water receiving surface 150e can be any one of a number of different sizes and/or configurations, all within the contemplation of this invention.

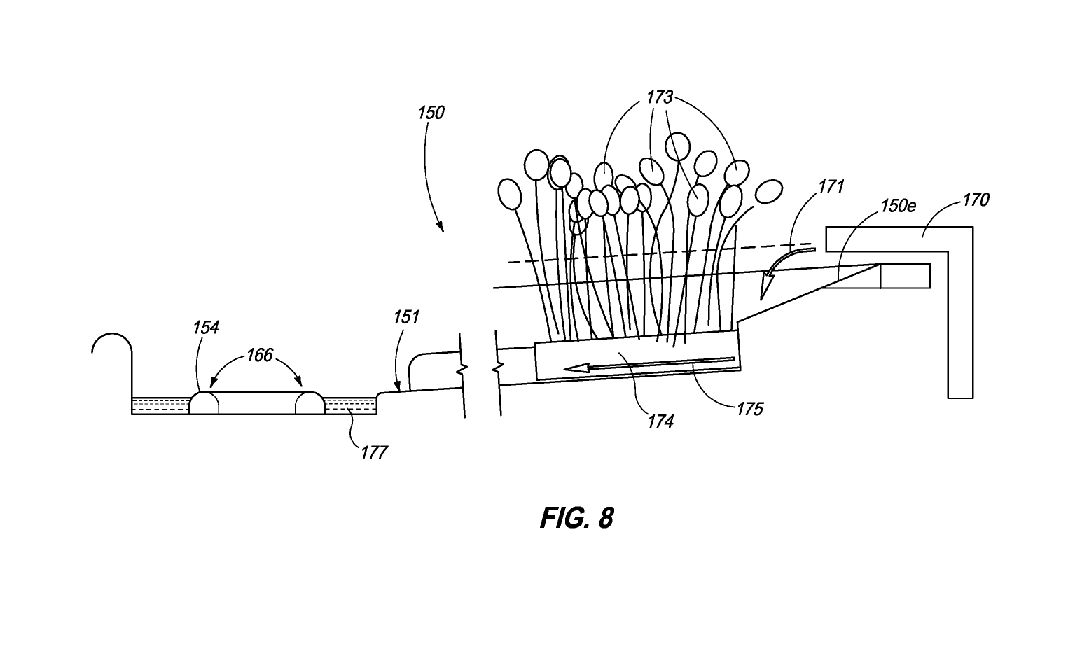

An additional aspect of the invention illustrated in the embodiment of the invention shown in FIG. 6 (and FIG. 8) is a sloping tray section at a predetermined drain angle 149 to the drain portion 147. The sloped portion of the tray provides the slope selected for the predetermined water flow and drainage for the given application, and a better drain hole configuration to provide for the water flow through the drain aperture while preventing undesired debris from entering (and clogging) the drain aperture (shown in FIG. 7 as an example). One example in an embodiment of this invention utilizes a slope in the slope portion of the tray of a two-inch drop (148) over a four-foot length 153 of the tray 150. With the top of the drain 146 being level the need for an optional screen over the drain aperture in the drain 146 is reduced and/or eliminated, along with minimizing the upstream effect of causing water flowing through the tray to stagnate or back up inside the tray 150.

FIG. 7 is a cross-sectional elevation view of the example of the tray 150 shown in FIG. 6, illustrating tray first side 150b, water receiving surface 150e, drain 166 with raised drain perimeter 154 (which is raised height 169). Arrow 165 represents water introduced to the tray 150 and arrow 168 represents water flowing through a drain aperture in drain 166. The raised perimeter 154 can be different heights 169 depending upon the specific application and the nature of the debris generated thereby, with no one particular configuration, height or sizing being required to practice this invention.

FIG. 8 is an elevation view of a tray 150 configuration schematic which may be utilized in some embodiments of this invention, illustrating water supply conduit 170, water receiving surface 150e, water 171, crop 173 (which in this example are micro greens), water flow 175 through growth medium 174, bottom surface 151 of tray 150, raised perimeter 154 of drain 166. Item 177 would typically represent a combination of water and/or debris surrounding the raised perimeter 154 of drain 166.

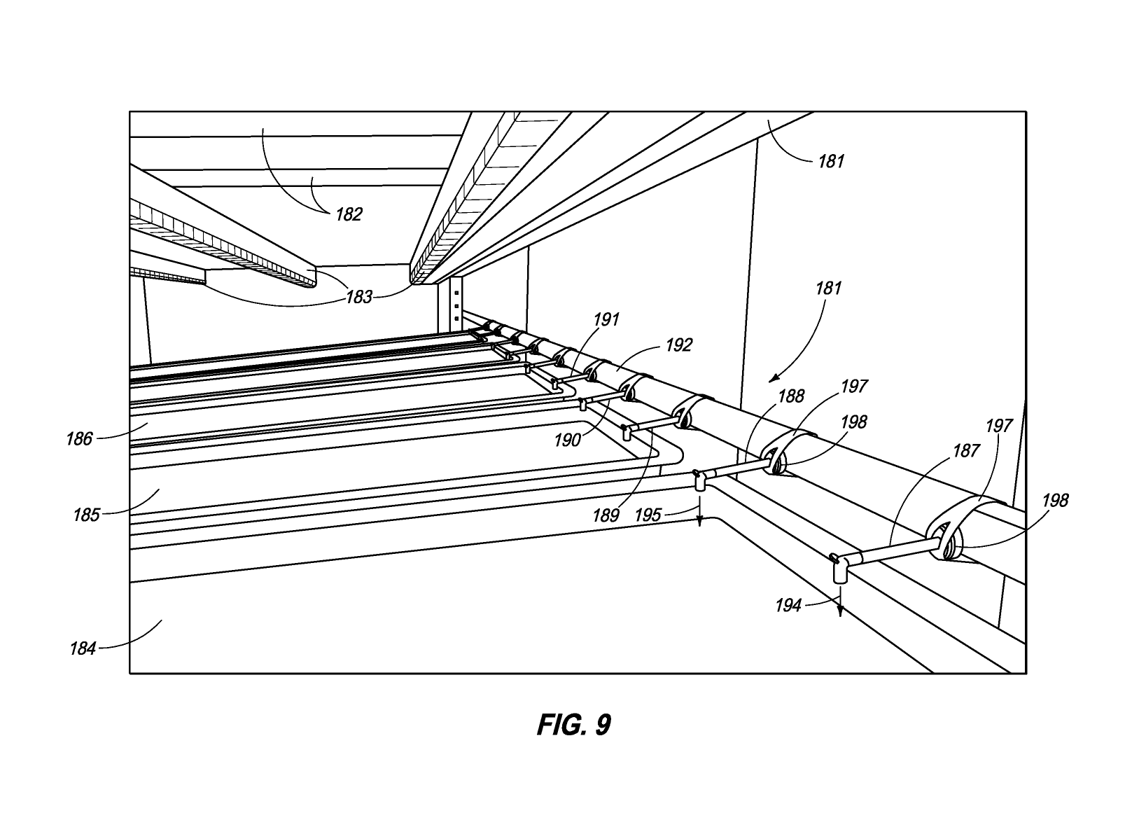

FIG. 9 is a side perspective view of trays 184, 185 and 186 in place on the shelf liner. FIG. 9 showing the water input pipes 187, 188, 189, 190 and 191, grow lights 183 and a pallet rack framework 181. Water conduit 192 feeds water into the water input pipes 187, 188, 189, 190 and 191, which deliver the water 194 and 195 into the respective trays 184, 185 and 186. Shelf liner supports trays 184, 185 and 186. The framework 181 and 182 shown in this embodiment is a typical pallet rack. FIG. 9 further illustrates restraining straps 197 which are placed for additional strength and/or stabilization of the water input pipes (also referred to as an emitter tube).

It should be noted that in commercial type applications of embodiments of the invention, the main water conduits 192 may be relatively long (lengths such as forty feet or more). Over such lengths, there are pressure drops along the line and in lines elevated above the others. In embodiments of the invention it is desirable to achieve consistent water volume flow through each of the similarly arranged and/or planted trays. In aspects of this invention the water volume and flow rate goals may be accomplished through the use of installed pressure compensating emitters through “top hat” grommets—so that predetermined optimal flow rates can be reached or approached (one example being a flow rate of five to seven gallons per hour). This further allows for increased pressure through the network of water conduits 192 at various vertical locations in the pallet rack matrix. The use of the restraining straps 197 with friction fit rubber grommets 198 allows easy access into the water conduit 192 if desired, but also provides sufficient resistance to the water pressure in the water conduit 192 during the operation of the system.

As will be appreciated by those of reasonable skill in the art, there are numerous embodiments to this invention, and variations of elements and components which may be used, all within the scope of this invention. In one embodiment for example, a tray system may be provided for use in hydroponic growing, comprising: a framework which includes at least one shelf; a shelf liner sized and configured for placement on the at least one shelf of the framework; a hydroponic grow tray sized and configured for placement on the shelf liner, the grow tray including a first side, a second side and a grow medium portion between the first side and second side, the tray configured in place such that there is a downward slope from the first side to the second side, the tray further comprising: a water receiving surface at the first side of the tray, the water receiving surface positioned to receive water from a source of water mounted to the framework, and sloped such that water received is directed to the grow medium portion of the tray; a tray drain at the second side of the tray configured to receive water from the grow portion.

In addition to the embodiment disclosed in the preceding paragraph, the invention may further include such a tray system: further wherein two or more of the hydroponic grow trays are similarly placed on the shelf liner; further wherein the shelf liner further includes a first side positioned below the first side of the tray and a second side positioned below the second side of the tray, and further comprises an elongated drain along the second side of the shelf liner such that the tray drain is vertically above the elongated shelf liner drain; further wherein the framework is a commonly sized pallet rack; further wherein the drain is at least partially surrounded by a raised perimeter sized to impede debris in the water from flowing into the tray drain; further wherein the grow portion of the tray provides the downward slope toward the second side of the tray; further wherein the tray is positioned on the shelf liner with the downward slope to provide the downward slope toward the second side of the tray; and/or further wherein the shelf liner and the tray are positioned on the framework at the downward slope to provide the downward slope toward the second side of the tray.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I/We claim:

1. A tray system for use in hydroponic growing, comprising:
a framework which includes at least one shelf;
a shelf liner sized and configured for placement on the at least one shelf of the framework;
a hydroponic grow tray sized and configured for placement on the shelf liner, the grow tray including a first side, a second side and a grow medium portion between the first side and second side, the tray configured in place such that there is a downward slope from the first side to the second side, the tray further comprising:
a water receiving surface at the first side of the tray, the water receiving surface positioned to receive water from a source of water mounted to the framework, and sloped such that water received is directed to the grow medium portion of the tray;
a tray drain at the second side of the tray configured to receive water from the grow portion.

2. A tray system for use in hydroponic growing as recited in claim 1, and further wherein two or more of the hydroponic grow trays are similarly placed on the shelf liner.

3. A tray system for use in hydroponic growing as recited in claim 1, and further wherein the shelf liner further includes a first side positioned below the first side of the tray and a second side positioned below the second side of the tray, and further comprises an elongated drain along the second side of the shelf liner such that the tray drain is vertically above the elongated shelf liner drain.

4. A tray system for use in hydroponic growing as recited in claim 1, and further wherein the framework is a commonly sized pallet rack.

5. A tray system for use in hydroponic growing as recited in claim 1, and further wherein the drain is at least partially surrounded by a raised perimeter sized to impede debris in the water from flowing into the tray drain.

6. A tray system for use in hydroponic growing as recited in claim 1, and further wherein the grow portion of the tray provides the downward slope toward the second side of the tray.

7. A tray system for use in hydroponic growing as recited in claim 1, and further wherein the tray is positioned on the shelf liner with the downward slope to provide the downward slope toward the second side of the tray.

8. A tray system for use in hydroponic growing as recited in claim 1, and further wherein the shelf liner and the tray are positioned on the framework at the downward slope to provide the downward slope toward the second side of the tray.
